(19) United States
(12) Patent Application Publication
(10) Pub. No.: US 2011/0083145 A1
(43) Pub. Date: Apr. 7, 2011

(54) METHODS AND APPARATUS FOR COMBINING LOCAL VIDEO CONTENT IN A DIGITAL VIDEO STREAM

(76) Inventors: Chris Cholas, Frederick, CO (US); David G. Bell, Broomfield, CO (US)

(21) Appl. No.: 12/574,312

(22) Filed: Oct. 6, 2009

(51) Int. Cl. H04N 7/10

(52) U.S. Cl. 725/36

(57) ABSTRACT

Methods and apparatus for supporting local video insertion into a content delivery signal are described. PIDs are assigned at a headend to identify locally inserted content. A QAM carrier used for content insertion may be fully utilized between the headend and multiple customer premises. Upon receipt of a content delivery signal the QAM carrier to be used for content insertion is filtered out and, optionally, some packets are recovered. Video from a local source is digitized, packetized, identified by a PID specified by the headend to be used to identify locally inserted content, multiplexed with recovered packets obtained from the QAM carrier to be used for local content insertion and then modulated onto the QAM carrier to be used for local content insertion. The QAM carrier is then combined with the other carrier signals recovered from the content delivery signal to generate a signal including both the locally provided content and the remotely supplied content.

### FIELD OF THE INVENTION

The invention relates to methods and apparatus for inserting local video content, e.g., video content from a local analog camera or other locally available video content, into a digital video stream.

### BACKGROUND OF THE INVENTION

Apartment buildings, office buildings, warehouses and other similar customer premise locations often have analog camera for security purposes. For distribution of the signals from the analog cameras, customer premise locations often mix the analog video camera output with an analog cable signal which was then distributed, e.g., to multiple locations, within the building being monitored. By using an analog frequency which was not being used in the building for cable content delivery, the locally supplied analog video signal could be multiplexed with the analog cable signal without concern for signal interference and could be easily recovered by simply tuning to the frequency used to communicate the locally inserted video signal.

Because of the importance of video surveillance in many buildings, particularly in cities or other areas where large multi-unit buildings exist, cable companies have, in at least some cases, agreed to contracts which obligate the cable service provider to a building to support local video content, e.g., security camera feeds, to be distributed over the cable wiring in a building to facilitate security monitoring. These contractual obligations, as well as the desire not to render existing video surveillance systems obsolete have presented many cable companies with difficulties as they move towards all digital content delivery systems.

In order to achieve spectrum efficiency, in the case of digital video content delivery systems, video content corresponding to various programs which is to be delivered on different program channels, is digitized and communicated as packets. The digital packets include packet identifiers sometimes referred to as PIDs. In various systems including MPEG systems a PID may be implemented as a unique integer value used to identify elementary streams of a program in a single or multi-program Transport Stream. Since the PIDs map packets to a program, they can be used to identify packets corresponding to a program, e.g., one of various programs which may be communicated using the same frequency or set of frequencies. QAM modulation is often used to communicate digital signals for cable delivery. Through the use of PIDs and by modulating content corresponding to multiple channels to single carrier frequency associated with a frequency band, digital content delivery provides bandwidth efficiencies over analog content delivery where a single carrier frequency would communicate one, not multiple programs, at any given time.

While cable companies may leave an entire QAM frequency unused to allow local video to be inserted into a video content signal using that frequency, such an approach tends to be very inefficient since it requires the cable company to leave the entire frequency band corresponding to the carrier frequency to be used for local video insertion to go unused from the cable companies perspective. In the case of digital content delivery, this means that while the local video insertion may only correspond to one or a few program channels, and the QAM frequency could be used to support several channels beyond the number required for local content insertion, the entire frequency band needs to go unused. While leaving one or more QAM frequency bands unused allows for analog content to be mixed and delivered without interference from digital signals being transmitted in the same frequency band this is wasteful from a bandwidth perspective since the QAM frequency could have been used to deliver more program channels than are used for local video insertion. With the advent of on demand services, HDTV and other possible uses of the available bandwidth for content delivery, leaving QAM frequencies unused so that they can be used for local video content insertion is both costly and wasteful.

In the case of digital content delivery, the addition of local video content is complicated by the fact that program information, e.g., PIDs used to identify packets corresponding to an individual program, is needed to identify and recover packets corresponding to a particular program, e.g., TV program or particular surveillance camera from a QAM frequency used to communicate content corresponding to multiple video programs each of which normally corresponds to a different program channel. The program to PID mapping information is usually provided by the cable network headend as part of program information, e.g., program guide and/or channel number to frequency mapping information, communicated from the network headend to the customer premise. Modification of such guide information is non-trivial and may not be easily implemented at a customer premise site.

In view of the above, it should be appreciated that there is a need for methods and apparatus for using network bandwidth efficiently while allowing for local video insertion to occur at a customer premise site such as an apartment building or office which may contain a plurality of individual customer premise units, e.g., offices or apartments potentially corresponding to different end users. From the above discussion, it would be desirable if at least some of the new methods and apparatus could support the handling of feeds from legacy analog cameras and not require guide or channel to PID mapping information to be modified at a customer premise site, e.g., apartment or office building.

### SUMMARY OF THE INVENTION

Methods and apparatus for supporting local insertion of video content into a digital video stream are described. The methods and apparatus are particularly well suited for insertion of content from a local source, e.g., a local security camera or a local source of stored content, at a customer premise building, e.g., an apartment complex or office building which may include multiple customer premise units which may correspond to one or more customers.

In accordance with the invention, the guide and/or PID information supplied to end user devices, e.g., set top boxes, responsible for recovering digital video for display, is supplied and/or controlled from a location, e.g., a cable network headend, remote to the customer premise site where the video content insertion occurs. Accordingly, the customer premise equipment need not modify guides or add PID information to channel mapping to PID information which is distributed from the cable network headend.

In order to support local video insertion, the cable network headend assigns one or more PIDs to be used to identify packets corresponding to locally inserted video. The PIDs are included in channel mapping information distributed to the headend but may be considered “ghost” PIDs since the headend does not distribute any packets of video content including the PIDs. For example, different PIDs may be designated as corresponding to different Local video channels. While the “ghost” PIDs go unused at locations where video content is not locally inserted, the bandwidth available for content delivery may be fully utilized. For example, bandwidth which will be used at various locations for local video insertion may be used to deliver on-demand or particular program channels which are not subscribed to at the locations where local content insertion is to take place.

In accordance with the present invention, a portion of the data which can be communicated on a single QAM carrier can be used for local video insertion with the remaining portion of the carrier bandwidth being used to communicate one or more digital programs received at the customer premise where local content insertion occurs with the PIDs of packets communicated using the carrier allowing for distinction between locally inserted content and content corresponding to program channels communicated from the cable network headend.

In accordance with one exemplary embodiment, a local content insertion device receives as input a signal from, e.g., a cable network headend. The received signal is filtered to separate out the QAM carrier frequency to be used for content insertion from other QAM carriers.

The digital packets are recovered from the QAM carrier to be used for content insertion and subjected to a filtering operation. The local insertion device may be instructed to drop packets having particular PIDs, e.g., PIDs corresponding to on-demand content or content which is not to be delivered to any users at the customer premise at which the insertion device is located. Normally, the received content stream should not include any packets corresponding to the “ghost” PIDs, but if it does these packets are dropped. By using packet filtering, at least a portion of the bandwidth available to communicate packets on the QAM carrier which is used to communicate content to other customer premises is made available for insertion of locally supplied content.

Local content to be inserted and distributed at the customer premise, e.g., from one or more local analog cameras, is digitized if not received in digital form and subject to a video encoding process. A low cost MPEG-2 video encoder such as that found in a digital video recorder may, and in some embodiments is, used to perform the video encoding. Local content to be inserted may also be stored content retrieved from a local storage device, e.g., from a video file providing customer premise specific content such as a building map or local restaurant menu information.

Digital packets communicating content which is being inserted locally are identified using one or more of the “ghost” channel PIDs allocated by the network cable headend. For example, a lobby camera may be the source of content identified by a PID which corresponds to a “lobby video camera” program channel while content corresponding to a cash register monitoring camera might be identified by a PID indicated in the program guide simply as local program channel 2. Since there is little overhead associated with PIDs that may not be used, a large number of local program channels and corresponding PIDs may be allocated and communicated from the headend while a customer premise location may use only a small number of the PIDs available for local video insertion.

Locally generated video content packets, each including one of the “ghost” PIDs used to identify locally inserted content, are then combined with any packets which were recovered from the QAM carrier to be used for local content insertion that were not dropped by the packet filtering operation. Packets recovered from the QAM carrier which is used for local insertion and which are not dropped may be subject to processing to adjust one or more time stamps communicated by the packets to take into consideration packet processing and/or forwarding delays introduced by the local content insertion process.

The packets to be communicated on the QAM carrier used for local insertion are modulated onto the QAM carrier being used and then combined with the portion of the received cable signal remaining after filtering to remove the QAM carrier to be used for local content insertion.

In this manner, locally inserted content can be combined with content received from a headend using minimal hardware and without having to leave the QAM carrier used for local content insertion unused between the cable network headend and the customer premise locations where content insertion may occur.

STB's and/or other devices can use guide and program information to tune to the QAM carrier used to communicate a program channel of interest and to recover the packets corresponding to a user selected channel whether the packets correspond to locally inserted content or content from the headend.

While a cable network headend is used for purposes of explaining the invention, the headend may be a satellite headend or a remote server used for distributing content and PID to frequency band and/or PID to program channel information.

Various additional features and advantages of the present invention are discussed in the detailed description which follows.

### BRIEF DESCRIPTION OF THE DRAWINGS

FIG. 1 illustrates an exemplary communications network implemented in accordance with the present invention.

FIG. 2 illustrates an exemplary customer premise device which can be used for inserting the video content from local cameras into an incoming digital video stream, in accordance with the invention.

FIG. 3 which comprises the combination of FIGS. 3A and 3B, is a flowchart illustrating the steps of an exemplary method, in accordance with the invention.

FIG. 4 illustrates a plurality of exemplary frequency bands and corresponding content communicated in a content delivery signal e.g., a signal broadcast from a server in the communications system of FIG. 1, in accordance with one exemplary embodiment of the invention.

FIG. 5 illustrates exemplary frequency bands and corresponding content included in an output signal generated by the exemplary band reject filter of FIG. 2 in accordance with one exemplary embodiment of the invention.

FIG. 6 illustrates a frequency band and corresponding content included in an output signal generated by the exemplary band pass filter of FIG. 2 in accordance with one exemplary embodiment of the invention.

FIG. 7 illustrates exemplary frequency bands and corresponding content included in the output signal generated by the exemplary combiner shown in FIG. 2, in accordance with one exemplary embodiment of the invention.

### DETAILED DESCRIPTION

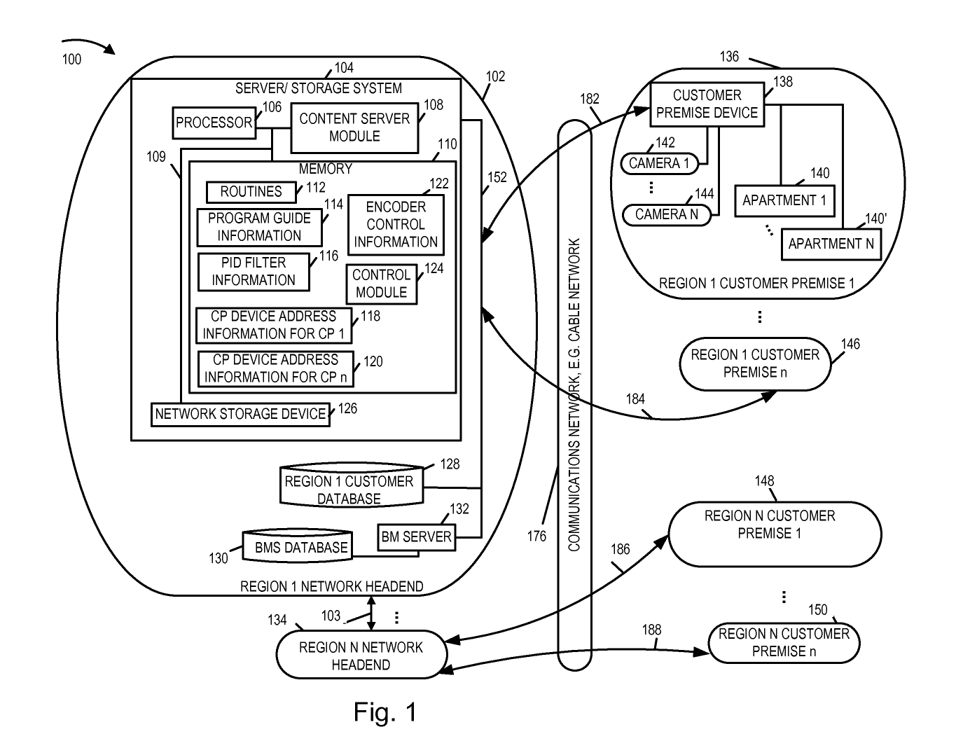

FIG. 1 illustrates an exemplary communications and distribution system 100 implemented in accordance with the invention. The system 100 also supports the provisioning, selection, notification, communication, and billing of content to customers. Exemplary system 100 includes a plurality of N regional service provider systems/Network headends including a region 1 service provider system/Region 1 Network headend 102 and a region N service provider system/Region N Network headend 134. Each regional service provider system, e.g., region 1 service provider system/headend 102, region N headend 134, has a corresponding set of customer premises. For example, region 1 headend 102 serves region 1 customer premise 1 136, . . . , region 1 customer premise n 146 while region N headend 134 may serve region N customer premise 1 148, . . . , region N customer premise n 150 each of which may include one or more customer premise devices.

Region 1 customer premise 1 136 is coupled to region 1 network headend 102 via a communications network 176, e.g. a cable network. Communications link 182 traversing the service provider's cable network 176 couples customer premise device (CPD) 138 to the region 1 network headend's bus 152. Similarly, region 1 customer premise n 146 is coupled to region 1 network headend bus 152 via link 184 which traverses service provider cable network 176.

Region N customer premise 1 148 is coupled to region N network headend 134 via a communications link 186. Similarly, region N customer premise n 150 is coupled to region N network headend 134 via a communications link 188. The network headends 102, 134 of the different regions are coupled together, e.g., via link 103.

Region 1 network headend 102 includes a Server/storage system 104, a region 1 customer database 128, and a business management (BM) server 132. The customer database 128 is used to store customer account information, e.g., customer name, address, STB identification information, STB capability information, and information about customer subscribed services. In addition to the above said elements, region 1 network headend 102 also includes a business management server (BMS) database 130 coupled to business management (BM) server 132. Various servers (104, 132) and database 128 are coupled together via a bus 152 over which they may interchange data and information. Business management server 132 processes billing information corresponding to region 1 customers, e.g., updating billing charge information in response to video on demand purchases, and/or other activity. Business management server 132 also processes bill payment information, e.g., credit card transactions, deductions from debit accounts, mail bills, and/or processes discount and/or coupon information.

The server/storage system 104 includes the content server module 108, memory 110, processor 106 and a network storage device 126 which are coupled together via a bus 109 over which various elements of the server/storage system 104 may exchange data and information. The processor 106, e.g., a CPU, executes routines 112 stored in the memory 110 and, under direction of the routines 112, controls general operations of the server/storage system 104.

The delivery of video and/or other content may, and normally is through content server module 108 that may output the content as a QAM (Quadrature Amplitude Modulated) signal that can be delivered over the cable network 176 to one or more customer premise devices such as device 138. In some embodiments the content server 108 provides video streams, e.g., broadcast streams, to the customer premise device (CPD) 138. These streams may be, scheduled broadcast streams, or Video on Demand (VOD) content streams generated in response to a VOD content request from a customer. In some embodiments the content server module 108 provides control information to the CPD 138 separately than the video-audio content, using a frequency band for communicating the control information which is different from the one used for communicating video-audio content. In some embodiments the content server module 108 may consult BMS 132 before proceeding with delivery of some program content, e.g., content customized for a customer premise, VOD content, to one or more customer premise devices such as device 138, in order to confirm whether or not the customer premise device is authorized to receive the on demand content. Network storage device 126 includes programs such as movies, content of regional favorites, content of seasonal favorites, etc. which can be broadcast to the customer premise devices.

Memory 110 includes routines 112, program guide information 114, program/packet identifier (PID) filter information 116, encoder control information 122, and a control module 124. In addition, a plurality of sets of device address information regarding the CPDs at various customer premises served by region 1 headend 102 are stored in the memory including customer premise device address information for customer premise 1 118, customer premise device address information for customer premise n 120. Customer premise device address information for customer premise 1 118 is the MAC address information regarding the CPD 136 in region 1 customer premise 136 while customer premise device address information for customer premise n 120 is the MAC address information regarding, e.g., one or more CPDs in region 1 customer premise n 146. The device address information may be used by the content server 108 to communicate control information to one or more CPDs to which the control information corresponds. The program guide information 114 in some embodiments includes information regarding the program content and associated program information, e.g., different packet identifiers (PIDs) associated with different programs broadcast on a program channel and the corresponding frequency at which the program channel can be viewed. Since PIDs correspond to programs they may be used to identify packets corresponding to a particular program. The program guide information 114 also includes program channel information, e.g., channel name and number, program title/name, scheduled program presentation time etc., which may be displayed in response to a user signal requesting the program guide to be displayed. Once the program guide information 114 is communicated to a customer device such as a set top box, it may and normally is stored by the device for future use.

The PID filter information 116 includes the information regarding the packet identifiers that correspond to data packets which are to be filtered out from a plurality of data packets in the content communicated to the CPD 138 from the content server module 108, in accordance with one aspect of the invention. This will be discussed in greater detail in the sections to follow. Encoder control information 122 includes control information which is communicated to the CPD 138 and is used by the CPD 138 to encode video from one or more cameras (142, 144). The control module 124 controls communication of various sets of control information stored in the memory 110, e.g., information 114, 116, 122 to one or more CPDs in region 1, e.g., CPD 138, which may then use the communicated control information to perform various tasks in accordance with the invention.

Region 1 customer premise 1 136 may be, e.g., a building or an office complex, including one or more apartments/offices such as apartment 1 140, apartment N 140′. In addition, region 1 customer premise 1 146 includes a customer premise device 138 to which a plurality of local cameras such as camera 1 142, . . . , camera N 144 are coupled. The local cameras 142, 144 provide video feed from one or more locations in the customer premise 1 136 to the customer premise device 138. An output from the customer premise device 138 is supplied to one or more of the apartments/offices in the customer premise 136. In some embodiments the output from the customer premise device 138 may be supplied to, e.g., a monitoring room and/or a distribution point, from where it may be selectively supplied to one or more apartments/offices in the region 1 customer premise 136.

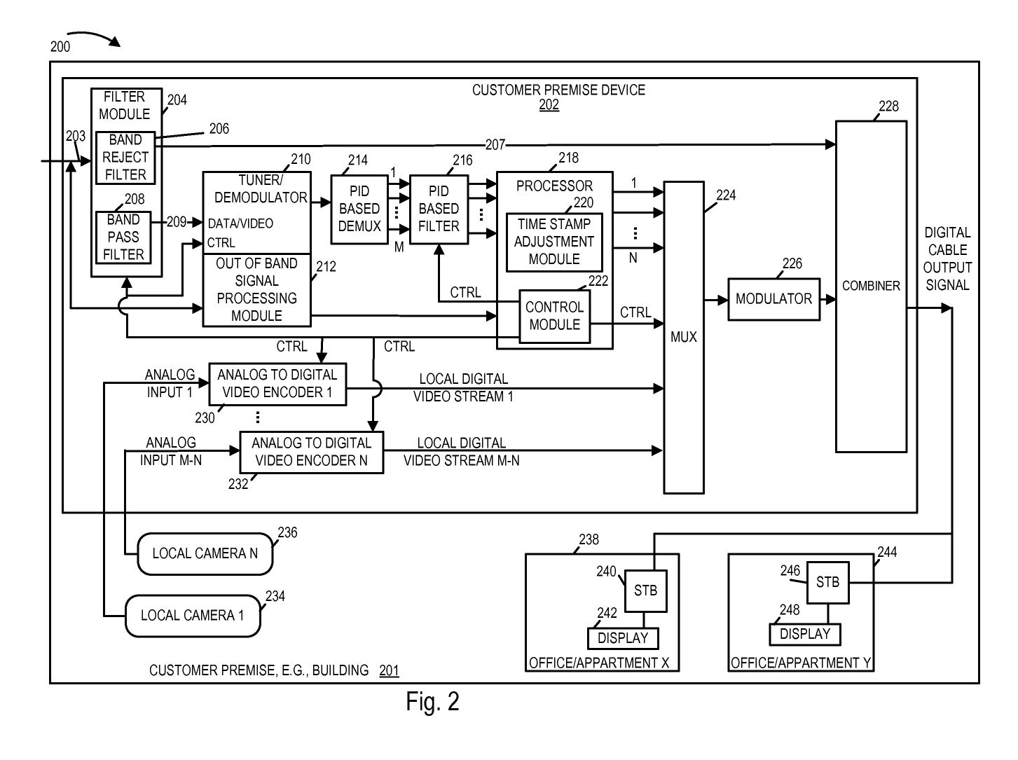

FIG. 2 illustrates an exemplary customer premise 201 which may be, e.g., a building with one or more apartments/offices. The customer premise 201 includes a customer premise device (CPD) 202 implemented in accordance with the invention, a plurality of local cameras including local camera 1 234 and local camera N 236, office/apartment X 238 and office/apartment Y 244. The exemplary customer premise 201 may be, e.g., region 1 customer premise 136 while the exemplary CPD 202 may be used as the customer premise device 138 shown in the system of FIG. 1.

The CPD 202 includes a filter module 204, a tuner/demodulator 210 coupled to a out of band signal processing module 212, a PID based demultiplexer 214, a PID based filter 216, a processor 218, a multiplexer 224, a modulator 226, a combiner 228, a plurality encoders including analog to digital encoder 1 230 and analog to digital encoder N 232. The filter module 204 includes a band reject filter module 206 and a band pass filter module 208. The processor 218 includes a time stamp adjustment module 220 and a control module 222.

In accordance with the invention, a QAM signal including a plurality of QAM frequency bands is received by the CPD 202, e.g., from the service provider headend 102. The received QAM signal including the plurality of QAM frequency bands is sometimes also referred to as the content delivery signal. The plurality of QAM bands are used to communicate digital video content from the headend 102. Among the plurality QAM frequency bands included in the received QAM signal, is a QAM frequency band which can be used for inserting locally provided digital video content at the customer premise. Independent of the received QAM signal, the CPD 202 also receives a control signal including control information from the headend 102. The control signal, in some embodiments, is received on a frequency band which is different from the one used for communicating the content delivery signal and is thus sometimes referred to as being received out of band. The control signal is an input to the out of band signal processing module 212 which recovers the control information from the control signal and provides the recovered control information to the control module 222 in processor 218. The control information received by the control module 222 includes information indicating the QAM frequency band into which locally provided digital video content can be inserted. Thus, using the control information the CPD 202 is able to identify the QAM frequency band among the plurality of QAM frequency bands in the received QAM signal, into which locally provided digital video content can be inserted. The received control information also includes the program guide information 114, PID filter information 116 and the encoder control information 122 discussed in the example of FIG. 1 earlier.

The received QAM signal including multiple QAM frequency bands is an input to the filter module 204. The filter module 204 is configured to filter the QAM frequency band into which the local digital video content can be inserted, from the received content delivery signal including multiple QAM frequency bands to produce a filtered content delivery signal. Using the control information indicating the QAM frequency band into which digital content can be inserted, the band reject filter 206 blocks or rejects the particular QAM frequency band while passing on the remaining QAM signal, e.g., the filtered content delivery signal, as represented by arrow 207. The band pass filter 208 however, also included in the filter module 204, lets the portion of the QAM signal including the particular QAM frequency band to pass through as represented by arrow 209, while blocking the received QAM signal with the remaining QAM frequency bands excluding the particular QAM frequency band into which local digital content can be inserted. Signal 209 which is the portion of the QAM signal with the QAM frequency band into which local digital content can be inserted is fed to the tuner/demodulator 210. The tuner/demodulator 210 demodulates the signal 209 to recover the data packets including digital content from the QAM frequency band of the received content delivery signal into which local video content is to be inserted. The demodulated output signal from the tuner/demodulator 210 is supplied to the PID based demultiplexer 214.

In some embodiments each one or a group of recovered data packets corresponding to, e.g., digital program content, from the identified QAM frequency band into which local digital content can be inserted, is identified by a packet identifier (PID). The PID based demux 214 demultiplexes the output from the demodulator 210 into separate data packets based on the PID. Each demultiplexed output from the PID based demux 214 is provided to the PID based filter 216 as an input. The PID based filter 216 performs a filtering operation on the received data packets from the PID based demux 214, using the control information regarding the PIDs received from the control module 222. The PID based filter 216 drops out or filters the data packets which are identified using PIDs that have been indicated by the control information to correspond to data packets which are to be removed, e.g., because the communicated content is not intended for any users at the customer premises where local content insertion may occur. Among the packets which are dropped are any packets including PIDs which are to be used for locally provided digital content. The PID based filter 216 however lets pass other data packets identified using different PIDs. The control information regarding the PIDs to be filtered is in at least some embodiments included in the control signal received from the headend 102 and processed by the out of band signal processing module 212. As will be discussed later in greater detail, the data packets identified using the PIDs indicated in the control information are dropped so that locally provided digital stream of data packets can be inserted in place of the dropped out data packets. The PIDs of the dropped out data packet are used again, in some embodiments, to identify the locally provided data packets which are inserted into the QAM frequency band. However, in some other embodiments different PIDs may be assigned or used to identify the locally provided data packets which are inserted into the QAM frequency band. The remaining data packets corresponding to the QAM frequency band are passed on to the processor 218 for further processing. The time stamp adjustment module 220 in the processor 218 adjusts the timing of the data packets received from the PID based filter 216 to account for the delay due to processing of data packets because of various operations, e.g., filtering, demultiplexing etc. performed by the device performing the local content insertion. The adjustment of time stamp information included in packets is optional and may not be performed in all embodiments.

The data packets output by the processor 218 are provided as inputs to the multiplexer 224 which is controlled by the processor 218. The multiplexer 224 also receives a plurality digital data streams as inputs, each one from an analog to digital video encoder, e.g., local digital video stream 1 from analog to digital video encoder 1 230, and local digital video stream N from analog to digital video encoder N 232. The analog to digital video encoders 230, 232 perform digital encoding operation on the analog video provided from the local cameras, e.g., local camera 1 234 and local camera N 236, to generate digital stream of data packets including video content from the local cameras 234, 236. The analog to digital video encoders 230, 232 receive control information from the control module 222 regarding the PIDs of the data packets which are dropped by the PID based filter and which have been indicated to correspond to data packets which are meant to be used for inserting locally provided digital content. In addition to digital encoding of the video from the camera, the digital video encoders 230, 232 are also configured to include, in the generated data packets including video content from the local cameras, packet identifiers indicated by the received control information. For example, the digital video encoder 1 230 may include a first PID indicated by the received control information in data packets including the video content from the local camera 1 234 while the digital video encoder N 232 may include a second PID indicated by the received control information in data packets including the video content from the local camera N 236.

The output from the analog to digital video encoders 230, 232 in the form of digital stream of data packets including the local video content is provided as separate inputs to the multiplexer 224. The multiplexer 224 also receive as inputs, the filtered and time adjusted data packets. The multiplexer 224 is configured to multiplex the data packets from the processor with the data packets including the local video content from the digital video encoders. The multiplexed output from multiplexer 224 is supplied to the modulator 226 which, as the name suggests, performs modulation to generate a local QAM signal. The locally generated QAM signal from the modulator 226 includes at least some received content, e.g., video content included in the recovered and filtered data packets, and at least some locally generated content, e.g., data packets including video content from local cameras.

The locally generated QAM signal from the modulator 226 is supplied to the combiner 228. Another input to the combiner 228 is the filtered content delivery signal which is the output from the band reject filter 206. The filtered content delivery signal (207) includes the portion of the originally received content delivery signal excluding the QAM frequency band into which digital content is inserted. The combiner 228 is responsible for combining the locally generated QAM signal including the local video content and corresponding to the QAM frequency band into which the local video content was supposed to be inserted (as indicated by the control information) with the filtered content delivery signal 207, to generate an output signal including the locally supplied video content and video content included in the filtered content delivery signal. The output signal from the combiner 228 is shown as digital cable output signal in FIG. 2.

The digital cable output signal may, and normally is provided to one or more offices/apartments in the customer premise 201. Each of the office/apartment in the customer premise may include a set top box (STB) which can receive the digital cable output signal from the combiner 228. For example, as shown in FIG. 2, office/apartment X 238 includes a STB 240 coupled to a display device 242 and the office/apartment Y 244 includes a STB 246 coupled to a display device 248. The STBs 240, 246 receive the digital cable output signal and display the program content on the display devices 242, 248 respectively. Although in some embodiments, the STBs 240, 246 are coupled to display devices, e.g. display 242, 248 respectively, which could be an external television, however, it should be appreciated that the STB 240 or STB 246 can be integrated in a device which also includes a display. The STBs receiving the digital cable output signal also receive the program guide information including information regarding the program content and associated program information, e.g., packet identifiers (PID) associated with different programs broadcast on a program channel, and the corresponding frequency at which the program channel can be viewed. Thus the STBs 240, 246 have information regarding the PIDs which are associated with the data packets including video content from local cameras 234, 236. In some embodiments the STBs 240, 246 may create a channel line up or a program guide to display to the user, using the received program guide information. In some embodiments the user is able to customize the program guide and create a user defined channel line up. Accordingly, regardless of the manner in which the program guide may be set, when the program guide is viewed, the user knows what program channels correspond to the locally provided video content from the local cameras 234, 236 and what program channels correspond to other regular program content broadcast from the service provider headend.

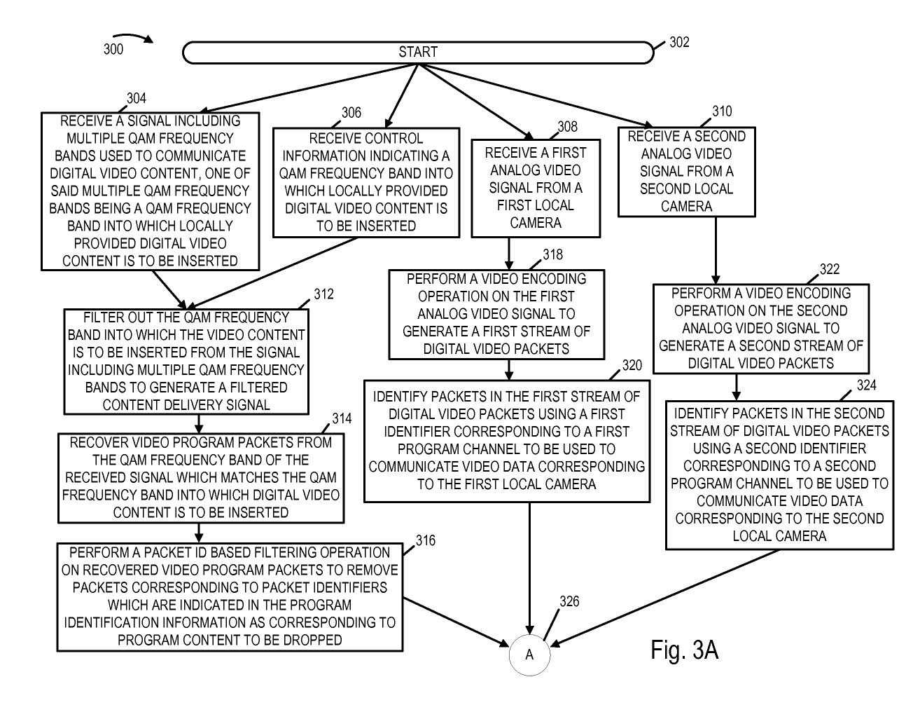

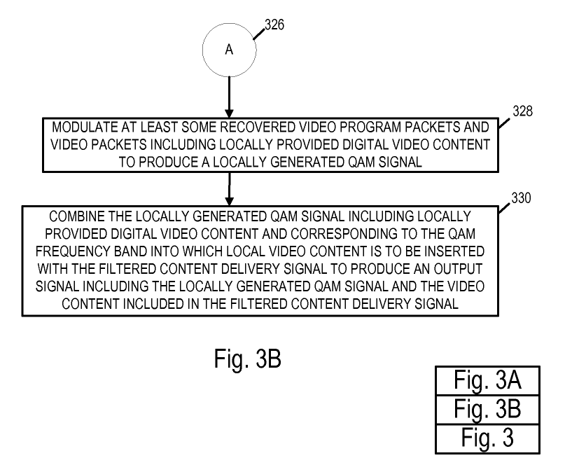

FIG. 3 which comprises the combination of FIGS. 3A and 3B is a flowchart 300 illustrating the steps of an exemplary method, in accordance with the invention. The method of flowchart 300 can be implemented by the customer premise device 138 of FIG. 1 and/or the customer premise device 202 of FIG. 2. The exemplary method starts in step 302 where a customer end device implementing the method, e.g., device 202, is powered on or initialized. To facilitate better understanding, the exemplary method of flowchart 300 will be discussed with reference to the customer end device 202 discussed in FIG. 2 example. The operation proceeds from start step 302 to steps 304, 306, 308 and 310 which may be performed in parallel and independent of each other, in at least some embodiments.

In step 304 the customer premise device 202 receives a signal including multiple QAM frequency bands used to communicate digital video content, e.g., from a service provider headend, one of the multiple QAM frequency bands being a QAM frequency band into which locally provided digital video content is to be inserted. Referring to the example of FIG. 2, the received signal is, e.g., the content delivery signal including multiple QAM frequency bands. Operation proceeds from step 304 to step 312.

In step 306 the device 202 receives control information indicating the QAM frequency band included in the plurality of QAM frequency bands in the received signal, into which locally provided digital video content is to be inserted. In some embodiments the control information is received over a frequency band by the device 202 which is different than the one over which the content delivery signal is received. In some embodiments the control information further includes packet identifiers (PIDs) to be used to identify locally inserted video content, different PIDs being associated with different program channels corresponding to different local video sources, e.g., different local cameras. For example, a first PID may identify data packets including video content from a camera located at a first location, e.g., at a hotel entrance, and the first PID may be associated with program channel 1. In such a case, the video content corresponding to the first camera can be viewed on program channel 1. Operation proceeds from step 306 to step 312.

In step 308, the device 202 receives a first analog video signal from a first local camera, e.g., at the analog to digital encoder 1 230 input. The first local camera may be located at a first location at a customer premise, e.g., at the entrance of a building. The operation proceeds from step 308 to step 318. In step 310, the device 202 receives a second analog video signal from a second local camera, e.g., at the analog to digital encoder N 232 input. The second local camera may be located at a second location, e.g., in the lobby of the building. The operation proceeds from step 310 to step 322.

Returning to step 312. In step 312 the QAM frequency band into which the digital video content is to be inserted is filtered out, from the content delivery signal including multiple QAM frequency bands, to generate a filtered content delivery signal. The filtering operation is performed by a filter such as the filter module 204 in device 202, to generate the filtered content delivery signal 207. Operation proceeds from step 312 to step 314. In step 314, the video program packets from the QAM frequency band of the received content delivery signal which matches the QAM frequency band into which the digital video content is to be inserted are recovered. The recovery of the video program packets can be performed by the tuner/demodulator 210 in some embodiments, as in the FIG. 2 example.

Operation proceeds from step 314 to step 316. In step 316 a PID based filtering operation is performed on the recovered program video packets to remove or drop out the data packets corresponding to PIDs which are indicated in packet identification information identifying program content packets, e.g., video program packets, to be dropped from the recovered video program packets. In some embodiments the packet identification information, e.g., the PIDs, identifying the program packets to be dropped is included in the control information received by the device 202 (in step 306). The PID based filtering operation can be performed by a filter module, e.g., PID based filter 216, using the control information. In some embodiments the customer premise device 202 implementing the method is at a first customer premise, e.g., premise 201, and the program content to be dropped is used by customers at customer premises other than the first customer premise 201. Thus it should be appreciated that in some embodiments, customized control information can be communicated to one or more customer premise devices while the content delivery signal still being the same for these customer premise devices. Thus the program packets dropped at a first customer premise based on the control information for the first customer premise may not be dropped and can still be used at a second customer premise. Operation proceeds from step 318 to step 328 via connecting node 326.

Returning to step 318. In step 318 a video encoding operation is performed on the first analog video signal received from the first camera, to generate a first stream of digital video data packets. Again referring to FIG. 2 example, the encoding operation is performed by the analog to digital video encoder 230 to generate the first stream of digital data packets. The operation proceeds from step 318 to step 320 wherein the digital video encoder 230 identifies the data packets in the first stream of digital data packets using a first identifier, e.g., a PID, corresponding to a first program channel to be used to communicate video data corresponding to the first local camera 234. The digital video encoder identifies the data packets by including said identifier in these data packets. As discussed earlier, in some embodiments the information regarding the PIDs to be used to identify the data packets including the locally inserted video content, is included in the control information received by customer premise device 202. In some embodiments different PIDs are associated with different program channels corresponding to different local cameras at the customer premise 201. Thus, data packets including video content from local camera 1 234 identified using a first identifier, are associated with a corresponding program channel, e.g., channel 1 which a user/customer can view. The operation proceeds from step 320 to step 328 via connecting node 326.

Returning to step 322. In step 322 a video encoding operation is performed on the second analog video signal received from the second camera, e.g., local camera N 236, to generate a second stream of digital video data packets. Referring to FIG. 2 example, the encoding operation can be performed by the analog to digital video encoder N 232 to generate the second stream of digital data packets. The operation proceeds from step 322 to step 324 wherein the digital video encoder N 232 identifies the data packets in the second stream of digital data packets using a second identifier, e.g., a PID, corresponding to a second program channel to be used to communicate video data corresponding to the second local camera, e.g., camera 234. The digital video encoder N 232 identifies the data packets by including the second identifier in these data packets. The second identifier may be associated with a second program channel corresponding to local camera N 236 at the customer premise 201. Thus, data packets including video content from local camera N 236 and identified using the second identifier may be viewed by the user/customer on the associated second program channel, e.g., channel 2. The operation proceeds from step 324 to step 328 via connecting node 326.

In step 328, a modulation operation is performed on at least some recovered video program packets (e.g., which remain after the PID based filtering operation) and video packets including locally provided digital video content to produce a locally generated QAM signal. The modulation can be performed by the modulator 226 discussed in FIG. 2. Thus the modulated signal, i.e., the locally generated QAM signal, includes at least some recovered video program packets and the video packets including the digital video content from the encoders.

Operation proceeds from step 328 to step 330. In step 330, a combining operation is performed to combine the locally generated QAM signal (which is the output from the modulator) including the locally provided digital video content and corresponding to the QAM frequency band into which digital video content is to be inserted, with the filtered content delivery signal (e.g., signal 207 shown in FIG. 2) to produce an output signal including the multiple QAM frequency bands used to communicate digital video content. As discussed earlier, the combining operation can be performed by the combiner 228 of FIG. 2, which receives input signals, e.g., filtered content delivery signal 207 from the filter module 204 and the locally generated QAM signal from the modulator 226. The output from the combiner 228 is the digital cable output signal, shown in FIG. 2, which includes the multiple QAM frequency bands used to communicate digital video content from the headend 102. It should be appreciated that included in the digital cable output signal is the video content from the local cameras 234, 236 which was turned into encoded and digital video packets by the encoders 230, 232 and inserted into one of the QAM frequency band. The digital cable output signal from the customer end device 202 is then supplied to one or more set top boxes located at the customer premise 201.

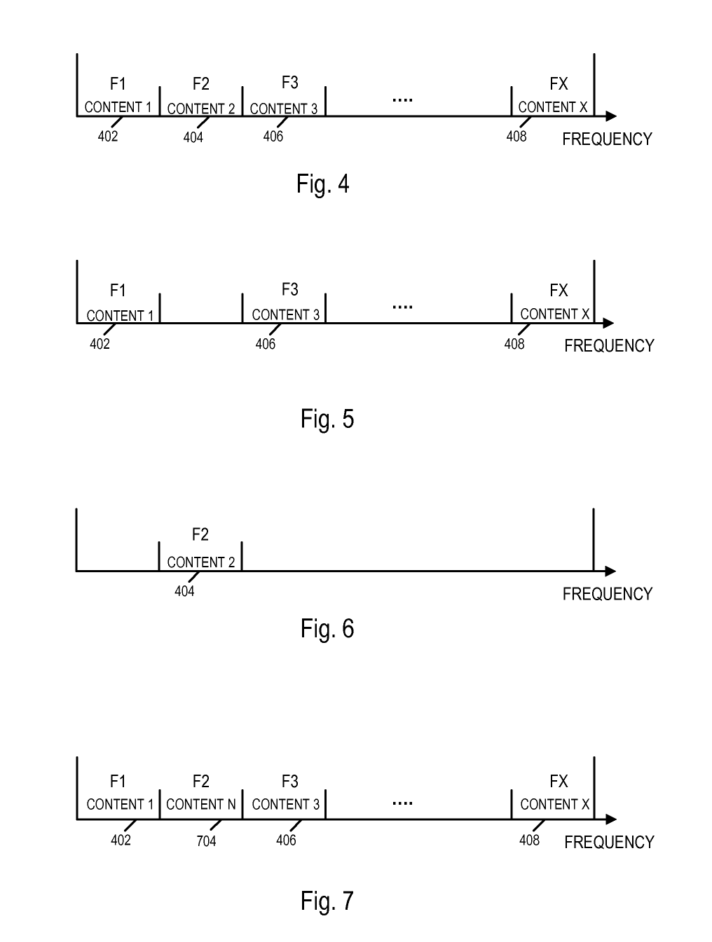

FIGS. 4 through 7 illustrate frequency bands and corresponding content communicated in various signals processed and/or generated by the customer premise device 202 in accordance with one exemplary embodiment of the invention. It should be appreciated that same reference numbers are used to identify same frequency bands in various signals shown in FIGS. 4 through 7. FIG. 4 illustrates the frequency bands and the corresponding communicated content present in the input signal to the filter module 204. The input signal is, e.g., the content delivery signal 203 of FIG. 2. Note that the content delivery signal 203 includes first through X QAM frequency bands F1 402, F2 404, F3 406, . . . , FX 408. Each of the frequency band can, and in some embodiments is, used to communicate multiple program channels, e.g., with each program channel communicating video, audio and/or data packets modulated on the signal corresponding to the frequency band used to transmit the particular program channel or channels. FIG. 5 represents the output of band reject filter 206, i.e., QAM frequency bands and the corresponding communicated content present in the filtered content delivery signal 207. As can be seen, the frequency band, e.g., F2, used for local video insertion, is removed from the input content delivery signal 203 to generate the output of band reject filter 206. In this manner, the original content of this band will not interfere or conflict with locally supplied content to be inserted into this frequency band. Notably, the deleted frequency band need not have been left unused but could, and in some embodiments is, used to communicate video and/or other content intended for another customer premise than the one at which customer premise device 202 is located. Alternatively, a portion of the band F2 may be used to communicate program content intended for customer premise device 202 with another portion being used to communicate content for another customer premise.

As discussed with regard to FIG. 2, in addition to generating the filtered output produced by band reject filter 206, the filter module 204 includes a band pass filter 208 for passing the frequency band eliminated from the filtered content delivery signal 207 generated by band reject filter 206, while rejecting other frequency bands. FIG. 6 illustrates an exemplary output of band pass filter 208. Note that the signal shown in FIG. 6 includes only the second frequency band portion F2 404 of the input signal shown in FIG. 4. This frequency band is either discarded or subject to processing to recover some content which is then combined with locally supplied content before being modulated to generate a new QAM frequency band signal.

FIG. 7 illustrates the output signal generated by the exemplary combiner 228 shown in FIG. 2. As illustrated in FIG. 7, the output signal generated by the combiner 228 includes the QAM frequency band F1 402 and corresponding content 1, a different QAM frequency band F2 704 and corresponding content N, QAM frequency band F3 and corresponding content 3, . . . , and QAM frequency band FX and corresponding content X. Note that among various frequency bands present in the output signal, all but the frequency band F2 704, are the same which were present in the input content delivery signal 203. The only different frequency band present in the output signal from the combiner 228 is the locally generated QAM frequency band F2 704 into which locally supplied video content is inserted. In some embodiments, content N corresponding to the QAM frequency band F2 704 also includes a portion of content 2, e.g., at least some data packets corresponding to content 2, in addition to the locally supplied video content.

The techniques of the present invention may be implemented using software, hardware and/or a combination of software and hardware. In the case of software, computer executable instructions used to control a processor may be stored in memory or another storage device and then executed by a processor. The present invention is directed to apparatus, e.g., a customer premise device and/or other communications system elements which implement all or a portion of the present invention. It is also directed to methods, e.g., method of controlling and/or operating a device and/or communication system elements to implement one or more portions of the methods of the invention. The present invention is also directed to computer readable medium, e.g., ROM, RAM, CDs, hard discs, etc., which include computer readable instructions for controlling a machine to implement one or more steps in accordance with the present invention.

In various embodiments system elements described herein are implemented using one or more modules to perform the steps corresponding to one or more methods of the present invention, for example, receiving signal and/or information, filtering, modulating signals, performing video encoding, signal processing and/or signal combining steps. Thus, in some embodiments various features of the present invention are implemented using modules. Such modules may be implemented using software, hardware or a combination of software and hardware. Many of the above described methods or method steps can be implemented using computer executable instructions, such as software, included in a computer readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to a computer readable medium including computer executable instructions for causing a machine, e.g., processor and associated hardware, to perform one or more of the steps of the above-described method(s). Some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein.

At least one system implemented in accordance with the present invention includes individual means for implementing each of the various steps which are part of the methods of the present invention. Each means may be, e.g., an instruction, processor, hardware circuit and/or combination of elements used to implement a described step.

Numerous additional variations of the methods and apparatus of the present invention described above will be apparent to those skilled in the art in view of the above description of the invention. Such variations are to be considered within the scope of the invention.

What is claimed is:

1. A method of locally inserting digital video content into a digital data stream, comprising:
receiving control information indicating a QAM frequency band into which locally provided digital video content is to be inserted;
receiving a signal including multiple QAM bands used to communicate digital video content, one of said multiple QAM bands being said QAM band into which digital video content is to be inserted;
filtering out said QAM frequency band into which digital video content is to be inserted, from said signal including multiple QAM frequency bands, to generate a filtered content delivery signal;
combining a locally generated QAM signal, including said locally provided digital video content and corresponding to the QAM frequency band into which digital video content is to be inserted, with said filtered content delivery signal to produce an output signal including said multiple QAM frequency bands used to communicate digital video content.

2. The method of claim 1, further comprising:
recovering video program packets from the QAM frequency band of the received signal which matches the QAM frequency band into which digital video content is to be inserted; and
modulating at least some recovered video program packets and video packets including locally provided digital video content to produce said locally generated QAM signal.

3. The method of claim 2, wherein said received control information further includes:
program identification information identifying program content to be dropped from said recovered video program packets prior to said modulating.

4. The method of claim 3, further comprising:
performing a packet identifier based filtering operation on recovered video program packets to remove packets corresponding to packet identifiers which are indicated in said program identification information as corresponding to program content to be dropped.

5. The method of claim 4, wherein said method of locally inserting digital video content is performed at a first customer premise and wherein said program content to be dropped is program content used by customers at customer premises other than said first customer premise.

6. The method of claim 3, wherein said control information further includes:
identifiers to be used to identify locally inserted video content, different identifiers being associated with different program channels corresponding to different local video sources.

7. The method of claim 6, wherein said different local video sources are different analog cameras located at the customer premise at which said method of locally inserting digital video content is performed, the method further comprising:
receiving a first analog video signal from a first local camera;
performing a video encoding operation on the first analog video signal to generate a first stream of digital video packets; and
identifying packets in said first stream of digital video packets using a first identifier corresponding to a first program channel to be used to communicate video data corresponding to said first local camera.

8. The method of claim 7, further comprising:
receiving a second analog video signal from a second local camera;
performing a video encoding operation on the second analog video signal to generate a second stream of digital video packets; and
identifying packets in said second stream of digital video packets using a second identifier corresponding to a second program channel to be used to communicate video data corresponding to the second local camera.

9. An apparatus for local insertion of video content, comprising:
a control module for receiving control information indicating at least a QAM frequency band into which local video content is to be inserted;
a filter module for filtering out said QAM frequency band into which local video content is to be inserted from a received content delivery signal including multiple QAM frequency bands, said filter module generating a filtered content delivery signal;
a combiner module for combining a locally generated QAM signal including locally provided video content and corresponding to said QAM frequency band into which local video content is to be inserted with said filtered content delivery signal to generate an output signal including said locally supplied video content and video content included in said filtered content delivery signal.

10. The apparatus of claim 9, further comprising:
a tuner-demodulator module for recovering packets including digital content from the QAM frequency band of said received content delivery signal into which local video content is to be inserted;
a multiplexing module for multiplexing recovered packets with video packets including locally provided video content; and
a modulator for generating said locally generated QAM signal from packets output by said multiplexing module, said locally generated QAM signal including at least some received content and at least some locally generated content.

11. The apparatus of claim 10, wherein said modulator generates said locally generated QAM signal in the QAM frequency band into which local video content is to be inserted.

12. The apparatus of claim 11, further comprising:
a packet identifier based filter for dropping packets recovered by said tuner-demodulator module which include packet identifiers which said control information indicates are to be dropped.

13. The apparatus of claim 10, further comprising:
a video encoder for generating packets including local video content from video provided by a first local video camera, said video encoder including in packets including video content from said first local video camera, a first identifier indicated by said received control information.

14. The apparatus of claim 13,
wherein said video encoder is also for generating packets including local video content from video provided by a second local video camera, said video encoder including in packets including video content from said second local camera, a second identifier indicated by said received control information.

15. An apparatus for local insertion of video content, comprising:
means for receiving control information indicating at least a QAM frequency band into which local video content is to be inserted;
means for filtering out said QAM frequency band into which local video content is to be inserted from a received content delivery signal including multiple QAM frequency bands, said means for filtering generating a filtered content delivery signal;
means for combining a locally generated QAM signal including locally provided video content and corresponding to said QAM frequency band into which local video content is to be inserted with said filtered content delivery signal to generate an output signal including said locally supplied video content and video content included in said filtered content delivery signal.

16. The apparatus of claim 15, further comprising:
means for recovering packets including digital content from the QAM frequency band of said received content delivery signal into which local video content is to be inserted;
means for multiplexing recovered packets with video packets including locally provided video content; and
means for generating said locally generated QAM signal from packets output by said means for multiplexing, said locally generated QAM signal including at least some received content and at least some locally generated content.

17. The apparatus of claim 16, further comprising:
means for dropping packets recovered by said means for recovering packets which include packet identifiers which said control information indicates are to be dropped.

18. The apparatus of claim 16, further comprising:
means for generating packets including local video content from video provided by a first local video camera, said means for generating packets including in packets including video content from said first local video camera, a first identifier indicated by said received control information.

19. A computer readable medium including computer executable instructions for controlling an apparatus, said computer readable medium comprising:
instructions for causing said apparatus to receive control information indicating a QAM frequency band into which locally provided digital video content is to be inserted;
instructions for causing said apparatus to receive a signal including multiple QAM bands used to communicate digital video content, one of said multiple QAM bands being said QAM band into which digital video content is to be inserted;
instructions for causing said apparatus to filter out said QAM frequency band into which digital video content is to be inserted, from said signal including multiple QAM frequency bands, to generate a filtered content delivery signal;
instructions for causing said apparatus to combine a locally generated QAM signal, including said locally provided digital video content and corresponding to the QAM frequency band into which digital video content is to be inserted, with said filtered content delivery signal to produce an output signal including said multiple QAM frequency bands used to communicate digital video content.

20. The computer readable medium of claim 19, further comprising:
instructions for causing said apparatus to recover video program packets from the QAM frequency band of the received signal which matches the QAM frequency band into which digital video content is to be inserted; and
instructions for causing said apparatus to modulate at least some recovered video program packets and video packets including locally provided digital video content to produce said locally generated QAM signal.
